(19) United States
(12) Patent Application Publication
(10) Pub. No.: US 2015/0023789 A1
(43) Pub. Date: Jan. 22, 2015

(54) Wind Turbine Power Augmentation

(71) Applicant: Massachusetts Institute of Technology, Cambridge, MA (US)

(72) Inventors: Sheila E. Widnall, Lexington, MA (US); James Byron, Alexandria, VA (US); Peter Florin, Berkeley, CA (US)

(21) Appl. No.: 14/197,500

(22) Filed: Mar. 5, 2014

Related U.S. Application Data
(60) Provisional application No. 61/846,779, filed on Jul. 16, 2013.

(51) Int. Cl. F03D 1/04

(52) U.S. Cl. CPC F03D 1/04
USPC 415/211.1

(57) ABSTRACT

Wind power generator. The generator includes a wind turbine rotating in an aerodynamically contoured duct and capable of generating increased power by increasing the wind flow at the turbine. A wind turbine is located at the entrance to a diverging duct. The duct expands in the wind direction following the wind turbine section, increasing the flow. A porous disk is located at the trailing edge of the aerodynamically contoured duct and this disk reduces die pressure at the trailing edge of the duct thereby sharply accelerating the flow through the duct and increasing die power output of die wind turbine. The porosity of the disk can be geometrically modified such dial the flow field changes to respond to changing wind conditions.

This application claims priority to U.S. provisional patent application Ser. No. 61/846,779 filed Jul. 16, 2013, the contents of which are incorporated herein by reference.

### BACKGROUND OF THE INVENTION

This invention relates to wind turbines and more particularly to a wind turbine rotating in a ducted cylindrical body and having a laterally-extending porous disk located at a trailing edge of the duct to reduce pressure at the trailing edge of the duct thereby accelerating flow through the duct and increasing power output of the wind turbine.

The power output of a bare (unducted) wind turbine, FIG. 1, is limited to roughly 59% of the power in the wind that flows through the circular disk area formed by the rotation of the blades; this is the so-called Betz limit which has firm analytical foundations and agrees with results in actual applications.

To overcome this limitation, for many years various proposals have been put forward to encase a turbine rotor in a converging-diverging duct, or diffusor. These efforts have had some success but have been hampered by the occurrence of flow separation inside the diverging portion of the duct downstream of the rotor.

Many ideas have been put forward to solve the problem of flow separation. A fundamental approach to mitigate the effects of How separation is to re-energize the flow in the diffuser by bleeding air into the diffuser from the external flow, see FIGS. 2 and 3. An alternate approach is to lower the pressure at die exit of the duct and thereby reduce flow separation by placing an injector downstream of the duct exit, FIG. 4.

In a quite different prior art approach, a solid, laterally-extending flange 8 was placed at the trailing edge of the diffuser, FIG. 5. This solid flange 8 experienced unsteady flow separation and a vortex formed behind the flange. This reduced the pressure at the trailing edge of the diffuser, increasing mass flow through the duct, and mitigating flow separation. This led to increased power from the ducted wind turbine. FIGS. 6 and 7 show the three-dimensional geometry of two prior art realizations of this device with the solid flange 8.

Another effort to prevent flow separation in the diffuser, increase the mass flow through the duct, and produce an augmentation of power is shown in FIG. 8. In this prior art device, a secondary duct was built to completely enclose the turbine duct. Some realizations of this approach included a solid flange placed at the exit of the wind tunnel duct similar to that shown in FIG. 5. This approach attempts to simultaneously increase the pressure at the entrance to the duct and decrease the pressure downstream of the turbine exit, creating additional mass flow through the duct, which produces increased power.

Another important feature of wind turbine power systems is adaptability. To produce safe and efficient operation it is necessary to control the flow parameters and the power output to respond to changing wind conditions. Shown in FIG. 9 is an approach that attempts to utilize the approach of FIG. 8 combined with an adjustability that would control the airflow at the entrance to the turbine to respond to changing wind conditions.

Many of these and other prior art devices place unwarranted emphasis on increasing the pressure at the entrance to the duct. In reality the flow through the cylindrical duct wind tunnel is controlled primarily by the pressure at the exit of the duct. The flow is governed by the so-called Kutta condition which requires that the pressure at the exit of the duct in its internal flow is equal to the pressure at the exit in the external flow. Thus a more effective device will focus attention on controlling the pressure at the exit of the duct.

### SUMMARY OF THE INVENTION

The wind power generator according to the invention Includes an aerodynamically contoured diverging duct having an inlet and a trailing edge. A wind turbine is supported for rotation and located at the inlet of the diverging duct. A porous disk is located at the trailing edge of the diverging duct, the porous disk extending laterally from the trailing edge of the diverging duct for a selected distance. This arrangement reduces pressure at the trailing edge of the duct resulting in increased turbine power generation. In a preferred embodiment, a converging duct is placed at the inlet to the diverging duct with the wind turbine located at the minimum cross section of the duct that forms a throat, it is preferred that, the ratio of the area at the trailing edge of the duct to the wind turbine cross section is less than 3. It is preferred that the porous disk have a porosity in the range of 5-60%. It is preferred that the degree of porosity be adjustable.

In a preferred embodiment, the aerodynamically contoured duct minimizes flow separation in the duct. It is preferred that the porous disk have a width in the range of 10% to 150% of the radius of the duct at the duct, trailing edge. The porous disk may be a solid structure with holes therethrough to provide porosity. Alternatively, the porous disk comprises a structure of alternating radially disposed paddles and open spaces.

### BRIEF DESCRIPTION OF THE DRAWING

FIG. 1 is a schematic illustration of prior art bare wind turbines.

FIG. 2 is a perspective view of a wind turbine in which air is bled into the diffuser from the external flow through holes.

FIG. 3 is a cross-sectional view of a prior art wind turbine in which air is bled into the diffuser from the external flow.

FIG. 4 is a cross-sectional view of a wind turbine configuration to lower pressure at the exit of the duct by placing an injector downstream of the duct exit.

FIG. 5 is a cross-sectional view of a prior art wind turbine using a flange extending laterally from a trailing edge of the wind turbine diffuser.

FIG. 6 is a perspective view of another prior an device using a laterally extending flange.

FIG. 7 is a perspective view of a prior art wind turbine incorporating a solid flange at its exit.

FIG. 8 is a schematic diagram of a prior art wind turbine device in which a secondary duct completely encloses the turbine duct.

FIG. 9 is a perspective view of a prior art wind turbine that is adjustable to control airflow at the entrance to the turbine in response to changing wind conditions.

FIG. 10 is a perspective view of an embodiment of the invention disclosed herein and including a porous disk.

FIG. 11 is a graph providing results of theoretical calculations of augmented power output for a wind turbine of the invention.

FIG. 12 is a cross-sectional view of an embodiment of the porous disk including round holes.

FIG. 13 is a cross-sectional view of the porous disk 10 using radially extending paddies alternating with open space to provide a selected degree of porosity.

FIG. 14 is a perspective view of an embodiment of the invention that was tested in a wind tunnel

FIG. 15 is a graph showing test results for the non-dimensional power output of a wind turbine with various porous disks according to the invention.

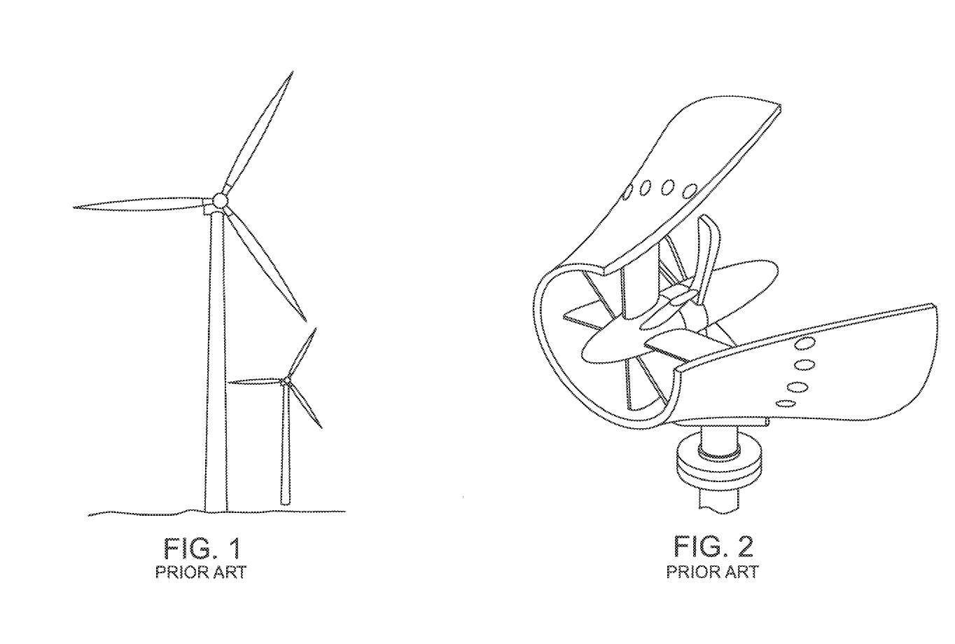

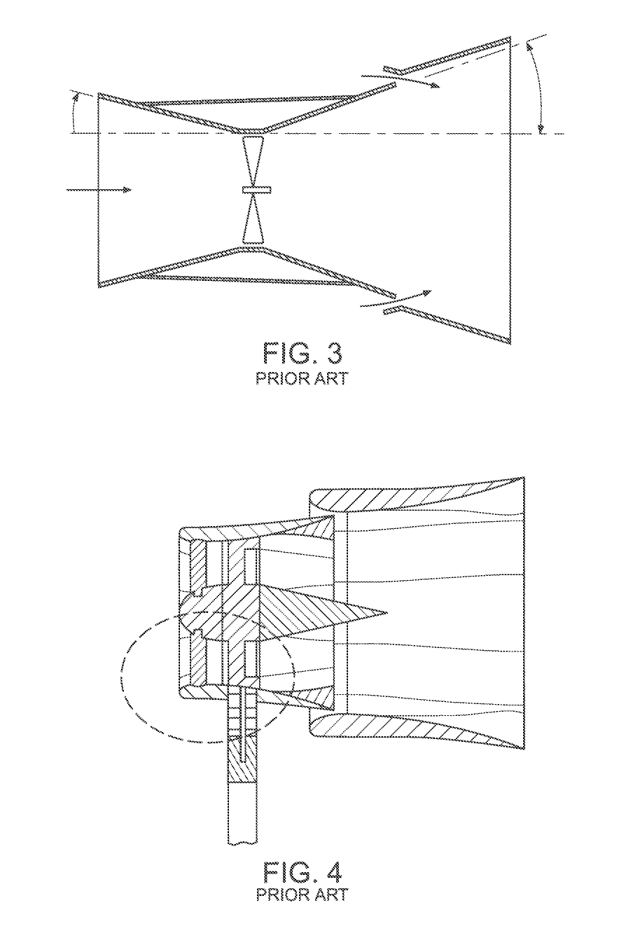

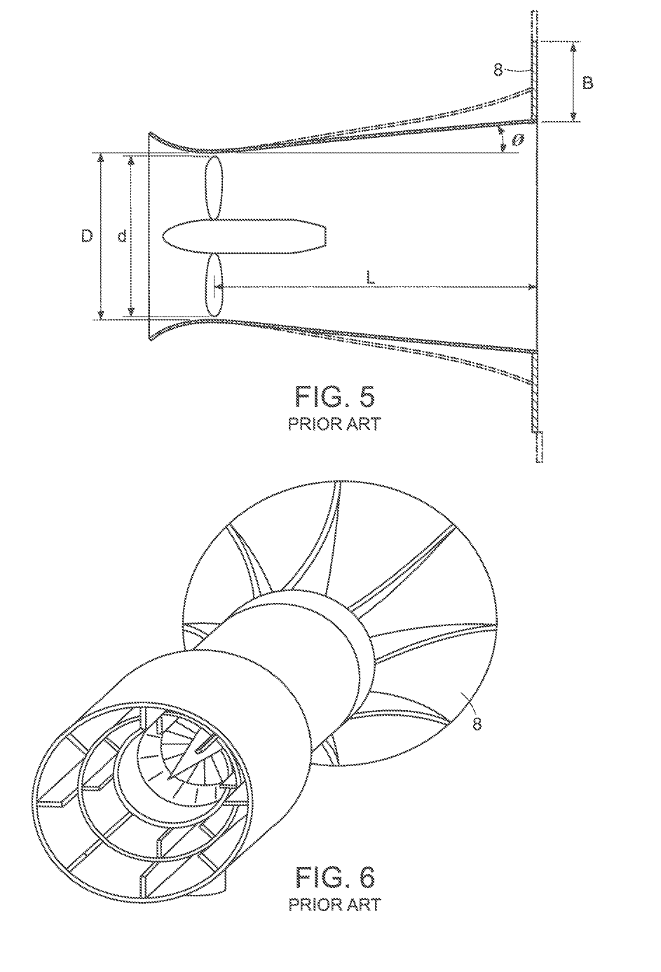

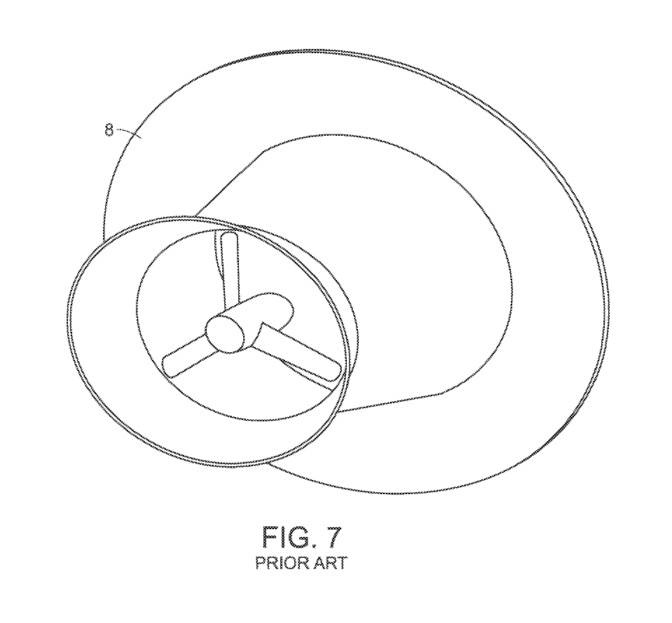

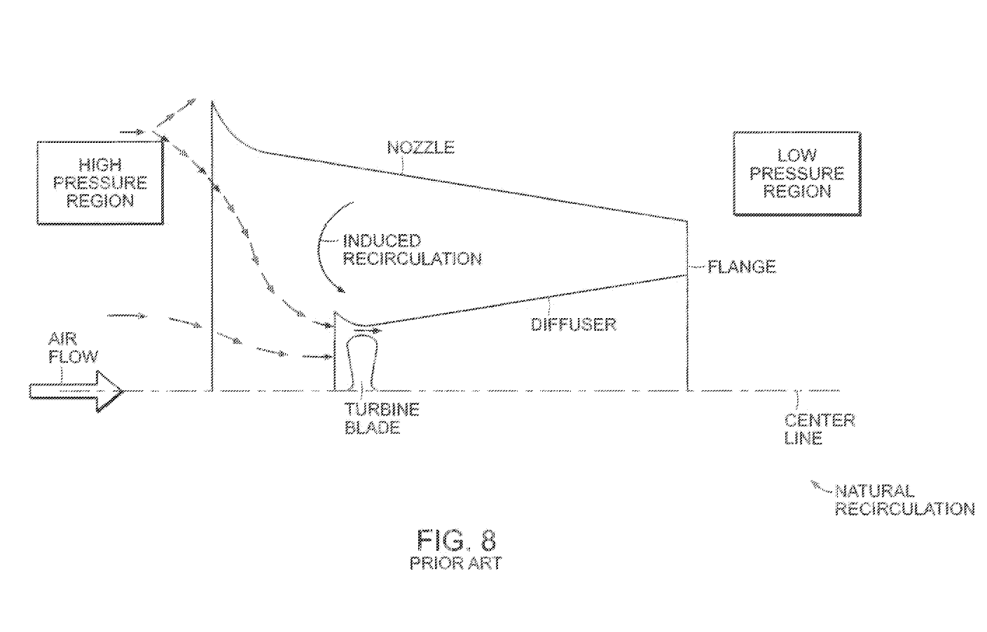

### DESCRIPTION OF THE PREFERRED EMBODIMENT

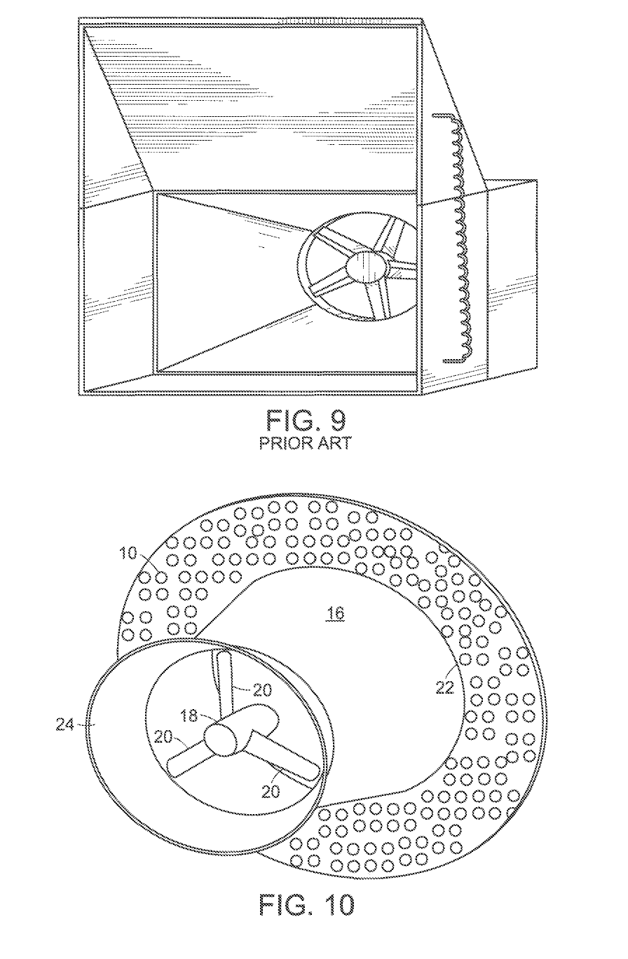

The present invention overcomes many of the obstacles of the prior art and provides increased power in a system that can be designed as well to adapt to changing wind conditions. The prior art. device of FIG. 5 in which a solid flange 8 is placed at the trailing edge to reduce the pressure at the trailing edge of the duct has several disadvantages. The flow behind the flange is unsteady, because of the large scale separation of the flow. And the geometry of the wind turbine system is not adaptable to allow efficient and effective operational response to changing wind conditions, in the present invention, this solid flange 8 is replaced by a porous disk 10, a typical embodiment of which is shown in FIG. 10.

The flow field behind a porous disk 10 depends upon the porosity of the disk which can range from 0% to 100%. The disk can also be characterized by its solidity where solidity=1−porosity. A practical range for the porosity of the disk for application to ducted wind turbines might be 5% to 60%. For non-zero porosities, the wake behind the porous disk 10 is steadier than the wake behind the solid disk 8 of zero porosity and the porosity can be adjusted by designing the porous disk 10 to allow geometric variation.

Calculations were performed to determine the power output of a ducted turbine, with an area ratio of 2 between its turbine station and its exit plane, augmented with a variety of trading-edge disk porosities, from a completely open disk, porosity=1 to a disk with porosity equal to 10%. The theoretical measure of porosity used in these calculations, Δ_{D}, refers to the decrease in velocity of the flow downstream/behind the porous disk relative to the free stream velocity, defined as Δ_{D}=1−U_{disk}/U_{∞}. It is qualitatively related to the geometric porosity (or solidity).

The non-dimensional power coefficient is plotted in FIG. 11 as a function of the decrease in velocity behind the duct wake relative to the free stream velocity Δ=1−U_{duct-wake}/U_{∞} for various disk porosities Δ_{D}.

Of interest is the magnitude and range of increased power, which nearly doubles over a wide range of flow parameters. Also shown for comparison in FIG. 11 is the theoretical Betz power curve, again plotted as a function of the decrease in flow velocity in the turbine wake, Δ.

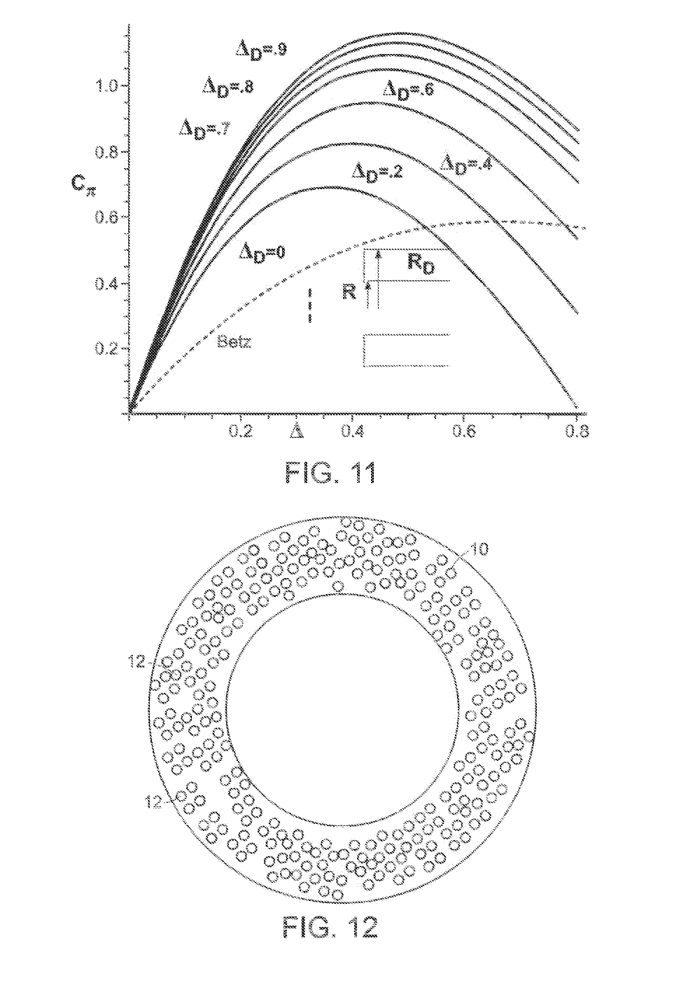

One advantage of the present embodiment is that the porosity of the disk can be adjusted to respond to changing wind conditions. Shown in FIGS. 12 and 13 are two geometric realizations of a porous disk 10: one a solid disk 10 with holes 12; the second, a set of paddles 14 (solid radial segments) with open spaces between them. In both cases, aligning two of either of these disks placed at the trailing edge of the duct and then rotating one of them would vary the porosity of the system to provide control over the power output, responding to wind conditions. Many other possible geometric arrangements that could easily provide variable porosity would be obvious to one skilled in the art.

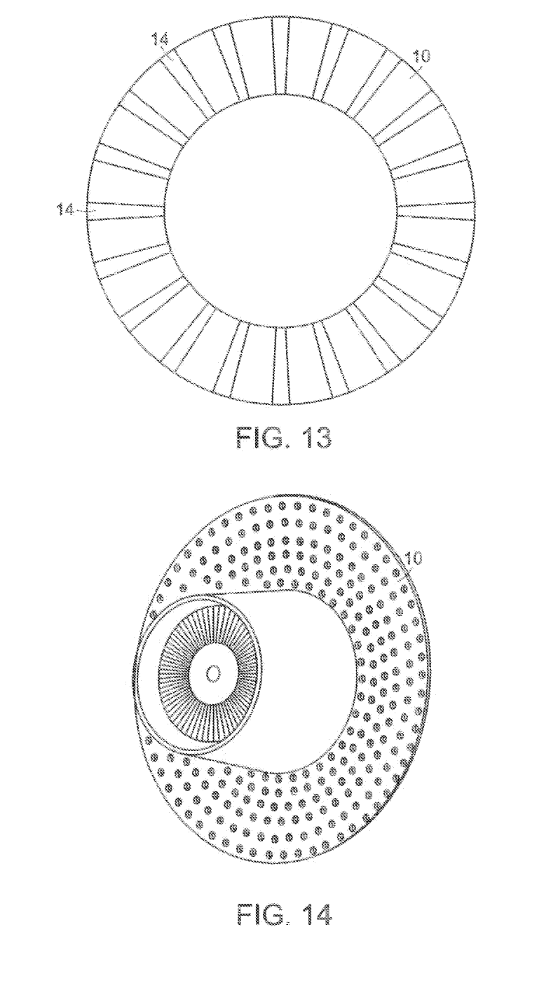

Wind tunnel tests were conducted to determine the power output from a variety of porous disks placed at the trailing edge of the diverging duct. The wind tunnel model is shown in FIG. 14. The ratio of the porous disk radius to the radius of the exit of the duct was two.

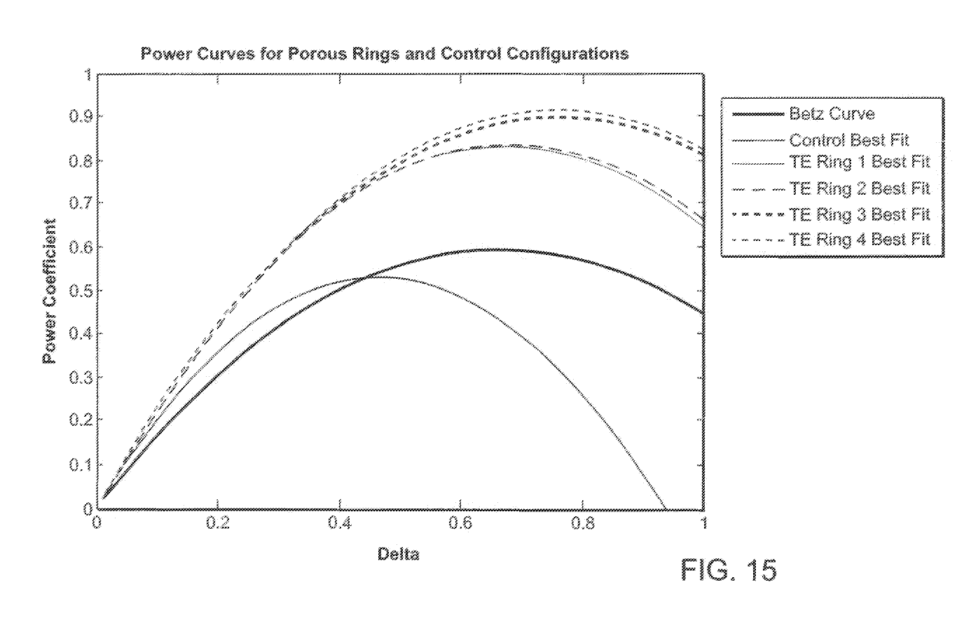

The geometric porosity varied from 50% to 0%. The action of the turbine itself upon the flow was simulated using a variety of disks of constant porosity located at the duct throat, as is done in actuator disk experiments. The experimental results are shown in FIG. 15. For each experiment, a specific porous disk was placed at the trailing edge of the duct. Then a variety of porous disks were placed at the throat of the duct to represent the effect of the power output of the turbine on the flow field. The change in duct wake velocity Δ and the mass flow through the duct throat, were measured. These two parameters determine the non-dimensional power output of the turbine. FIG. 15 shows the non-dimensional turbine power output coefficient for several porous disks, located at the trailing edge, over the range of turbine loadings defined by Δ. Again, the porous disks cause a dramatic increase in power output relative to the unmodified duct, nearly doubling the power output in some cases, depending upon the details of the geometry.

As shown in FIG. 10, a wind power generator of the present invention comprises a cylindrical wind tunnel body 16 and a wind turbine 18 for generating electricity, the wind turbine 18 being located within the duct followed by a diffuser, a cylindrical duct of increasing downstream area. Moving blades 20 of the wind turbine 18 rotate with some amount of clearance so as not to touch the inner wall surface of the duct.

The wind tunnel body 16 contains an expanding cylindrical tube (diffuser) which expands from the location of the turbine towards a trailing edge 22, the outlet for the wind. The cylindrical duct may also have a leading-edge area 24 greater than the area of the throat, forming a converging-diverging nozzle. In a typical embodiment, the ratio of the exit area of die diverging duct to the throat area would be less than 3.

The outlet of the wind tunnel body has a porous disk or flange 10 installed at the edge of the duct exit that can preferably range in width from 10% to 150% of the radius of the wind tunnel channel exit. The porosity of this disk preferably can range from 5% to 60%.

By disposing the wind power generator having the above structure in a flow of wind, the static pressure downstream of the porous disk 10, and thus at the outlet of the wind tunnel duct exit, is decreased, the flow is thereby accelerated through the wind tunnel duct, and die mass flow and the power output increases above that for a bare turbine and for a turbine in a converging-diverging duct without a downstream disk or flange.

The flow field behind the porous disk 10 is steadier than that behind a solid disk or flange reducing unsteady structural loads and resulting in a more predictable flow field. Also, the porous disk 10 can be designed to allow geometric variability, changing porosity and thus aerodynamic operating parameters to allow a system response to changing wind conditions.

The performance of an embodiment of the present invention is shown from theoretical calculation in FIG. 11 and from experimental results in FIG. 15. In both cases, application of the present invention can provide a significant increase in the power of a wind turbine system relative to art unmodified wind tunnel duct encapsulating the wind turbine*

A significant benefit is its geometric adaptability which provides a straightforward method to adapt the wind power system to changing wind conditions.

It is recognized that modifications and variations of the present invention will be apparent to those of ordinary skill in the art and it is intended that all such modifications and variations be included within the scope of the appended claims.

1. Wind power generator comprising:
an aerodynamically contoured diverging duct having an inlet and a trading edge;
a wind turbine supported for rotation located at the inlet to the diverging duct; and
a porous disk located at the trailing edge of the diverging duct, the porous disk extending laterally from the trailing edge of the diverging duct a selected distance, whereby pressure is reduced at me trading edge of the duct resulting in increased turbine power generation.

2. The generator of claim 1 wherein a converging duct is placed at the inlet to die diverging duct with the wind turbine located at the minimum cross section of the duct.

3. The generator of claim 1 wherein the ratio of the area at the trailing edge of the duct to the wind turbine cross-section is less than 3.

4. The generator of claim 1 wherein porosity of the porous disk is in the range of 5-60%.

5. The generator of claim 1 wherein porosity of the disk is adjustable.

6. The generator of claim 1 wherein the aerodynamically contoured duct minimizes flow separation in the duct.

7. The generator of claim 1 wherein the porous disk has a width in the range of 10% to 150% of the radius of the duct at the duct trailing edge.

8. The generator of claim 1 wherein the porous disk comprises a solid structure with holes therethrough to provide porosity.

9. The generator of claim 1 wherein the porous disk comprises a structure of alternating radially disposed paddle and open spaces.
